(19) United States
(12) Patent Application Publication
(10) Pub. No.: US 2025/0233699 A1
(43) Pub. Date: Jul. 17, 2025

(54) Method and Apparatus for Enhancing RLC Acknowledge Mode Under Exceeding Maximum Retransmissions and Dual-No Conditions

(71) Applicant: PURPLE MOUNTAIN LABORATORIES, Nanjing, Jiangsu (CN)

(72) Inventors: Qingguo SHEN, Nanjing, Jiangsu (CN); Yang LIN, Nanjing, Jiangsu (CN); Xiaofang HAN, Nanjing, Jiangsu (CN); Ruiqi QIU, Nanjing, Jiangsu (CN)

(21) Appl. No.: 18/730,706

(22) PCT Filed: Mar. 18, 2022
(86) PCT No.: PCT/CN2022/081582

§ 371 Date: Jul. 19, 2024

(30) Foreign Application Priority Data
Jan. 19, 2022 (CN) 202210061200.2

(51) Int. Cl. H04L 1/1867; H04L 1/1829; H04W 28/06

(52) U.S. Cl. CPC H04L 1/1883; H04L 1/1858; H04W 28/065

(57) ABSTRACT

Provided in the present disclosure are a method and apparatus for enhancing an RLC AM under exceeding maximum retransmissions and dual-no conditions. The method includes: when the number of retransmissions of the first message that has not been received by a receiving end reaches a preset threshold value, reconstructing the first message into a short message, and sending the short message to the receiving end; and when a polling timer expires and a dual-no condition is met, sending, to the receiving end, a second message having the minimum message SN in a set of messages for which positive acknowledgments of the receiving end have not been received. The dual-no condition is that no message in the sending buffer and the retransmission buffer can be sent at the current moment, and a new message cannot be sent due to no space in a sending window.

### CROSS-REFERENCE TO RELATED APPLICATION

This application claims priority to Chinese Patent Application No. 202210061200.2 filed on Jan. 19, 2022 and entitled “Method and Apparatus for Enhancing RLC Acknowledge Mode Under Exceeding Maximum Retransmissions and Dual-No Conditions”, the disclosure of which is hereby incorporated by reference in its entirety.

### TECHNICAL FIELD

The present disclosure relates to the technical field of wireless communications, and in particular, to a method and apparatus for enhancing a Radio Link Control (RLC) Acknowledge Mode under exceeding maximum retransmissions and dual-no conditions.

### BACKGROUND

In a 5th Generation/4th Generation (5G/4G) wireless network, a base station gNodeB (gNB) and a User Equipment (UE) communicate with each other through an air interface protocol. Data packets received by the base station from a Core Network (CN) are first subjected to Internet Protocol (IP) header compression and encryption by a Packet Data Convergence Protocol (PDCP) layer, then are transmitted to a Radio Link Control (RLC) layer, for segmenting and concatenating according to transmission requirements of a Media Access Control (MAC) layer, are then transmitted to the MAC layer, and are finally formed into air interface wireless signals for transmitting. A RLC protocol follows a 5G standard ts38.322 or a 4G standard ts36.322, and provides transmission service modes such as a Transparent Mode (TM), an Unacknowledge Mode (UM), an Acknowledge Mode (AM) and so on. The RLC AM is a connection-oriented service mode that may implement functions such as Automatic Repeat-reQuest (ARQ) error correction, duplicate packet detection, segmentation/reassembling, and RLC SDU discard processing. The functions provided by the RLC AM work in conjunction with a Hybrid Automatic Repeat-reQuest (HARQ) provided by the MAC layer to achieve a more reliable transmission service.

In the related art, a processing method under exceeding maximum retransmissions in the AM and the polling processing method in the AM performed by the RLC layer are respectively that: 1) when any Protocol Data Unit (PDU) exceeding the maximum number of retransmissions, connections of the RLC or even all air interface protocols of the corresponding UE must be disconnected. When only an individual PDU exceeds the maximum retransmissions, but the neighboring PDUs of the PDU have been received correctly, it may be determined that the quality of a radio link communication is good. However, in the existing standard, the practice is to report to the Radio Resource Control (RRC) layer, and the RRC layer disconnects and re-establish all the air interface protocol connections of the corresponding UE, seriously affecting all service flows of the UE in the UM and AM modes; 2) When polling needs to be sent after the expiration of the polling timer t-PollRetransmit, if a base station is under the condition (referred to as the dual-no condition) that no data in a sending buffer and a retransmission buffer may be sent, or a new message is not able to be sent due to no space in a sending window, the practice in the existing standard is to select a PDU having the maximum message Sequence Number (SN) in a set of messages that have been sent. However, the message may be located above the receiver highest_status, and the corresponding status report would be not able to be triggered timely, resulting in delayed retransmission of messages, for which positive acknowledgment is not received.

### SUMMARY

The present disclosure provides a method and apparatus for enhancing a Radio Link Control (RLC) Acknowledge Mode under exceeding maximum retransmissions and dual-no conditions, which are used to solve the problems that, when the number of retransmissions of an individual message exceeds the maximum number of retransmissions, RLC or even all air interface protocols of a corresponding User Equipment (UE) is immediately disconnected, resulting in too large impact, and under the dual-no condition, when t-PollRetransmit expires, a message having the maximum message Sequence Number (SN) is selected for retransmission and carrying Polling, such that the corresponding status report cannot be triggered timely, resulting in delayed retransmission of messages, for which positive acknowledgment is not received. Therefore, the communication rate and reliability of the UE are effectively improved, and the receiving end is triggered to send a status message as soon as possible, so as to avoid side effects.

The present disclosure provides a method for enhancing RLC Acknowledge Mode under exceeding maximum retransmissions and dual-no conditions. The method is applied to a sending end and includes the following operations:
when the number of retransmissions of a first message that has not been received by a receiving end reaches a preset threshold value, the first message is reconstructed into a short message, and the short message is sent to the receiving end. The first message is an RLC/AM data message, the short message is a special RLC/AM data message with a data field length being 0, and an SN of the short message is an SN of the first message;
when a polling timer expires and a dual-no condition is met, a second message having the minimum message SN in a set of messages for which positive acknowledgments of the receiving end have not been received, is sent to the receiving end. The dual-no condition is that no message in a sending buffer and a retransmission buffer can be sent at a current moment, and a new message cannot be sent due to no space in a sending window.

In an embodiment, before the first message that has not been received by the receiving end is retransmitted, the method further includes the following operation:
a status message sent by the receiving end is received, and a sending link available status timer for a receiving end is started, wherein the status message includes negative acknowledgment of the first message, and positive acknowledgments of other messages.

In an embodiment, the operation of when the number of retransmissions of the first message has not been received by the receiving end reaches the preset threshold value, the first message is reconstructed into the short message, and the short message is sent to the receiving end, includes the following operations:
when the number of retransmissions of the first message has not been received by the receiving end reaches the preset threshold value, if the sending link available status timer for the receiving end is in a valid status, the first message is reconstructed into the short message, and the short message is sent to the receiving end;
if the sending link available status timer for the receiving end expires, or the number of retransmissions of the short message reaches a preset threshold value, the short message is reported to an Radio Resource Control (RRC) to perform reconnection of air interface protocol.

In an embodiment, the operation of when the polling timer expires and the dual-no condition is met, the second message having the minimum message SN in the set of messages for which positive acknowledgments of the receiving end have not been received, is sent to the receiving end includes the following operation:
if the number of retransmissions of all messages in the set of messages for which positive acknowledgments of the receiving end have not been received, has reached the preset threshold value, the second message having the minimum message SN is selected and sent to the receiving end, otherwise the second message having the minimum message SN and the number of retransmissions not reaching the preset threshold value is sent to the receiving end.

The present disclosure further provides a method for enhancing RLC Acknowledge Mode under exceeding maximum retransmissions and dual-no conditions. The method is applied to a receiving end and includes the following operations:
a status message is sent to a sending end, wherein the status message includes negative acknowledgment of a first message has not been received, and positive acknowledgments of other messages;
a short message sent by the sending end is received, a status variable of a receiving window is updated according to the short message, and a status report is fed back to the sending end;
a second message carrying a Polling bit is received, wherein the second message is sent by the sending end; and an operation of sending the status message to the sending end is triggered according to the second message.

In an embodiment, the short message is a special RLC/AM data message with a data field length being 0, and an SN of the short message is an SN of the first message.

In an embodiment, the second message is a message having the minimum SN that is selected in a set of messages for which positive acknowledgments of the sending end have not been received.

The present disclosure further provides a sending end applied to a base station or UE. The sending end includes a first processing module and a second processing module.

The first processing module is configured to, when the number of retransmissions of a first message that has not been received by a receiving end reaches a preset threshold value, reconstruct the first message into a short message, and send the short message to the receiving end wherein the first message is an RLC/AM data message, the short message is a special RLC/AM data message with a data field length being 0, and an SN of the short message is an SN of the first message;

the second processing module is configured to, when a polling timer expires and a dual-no condition is met, a second message having the minimum message SN in a set of messages for which positive acknowledgments of the receiving end have not been received, is sent to the receiving end, wherein the dual-no condition is that no message in a sending buffer and a retransmission buffer can be sent at the current moment, and a new message cannot be able to be sent due to no space in a sending window.

In an embodiment, before retransmitting the first message that has not been received by the receiving end, the first processing module is further configured to:
receive a status message sent by the receiving end, and start a sending link available status timer for a receiving end, wherein the status message includes negative acknowledgment of the first message, and positive acknowledgments of other messages.

The present disclosure further provides a receiving end applied to a base station or UE. The receiving end includes a third processing module, a fourth processing module, and a fifth processing module.

The third processing module is configured to send a status message to a sending end, wherein the status message includes negative acknowledgment of a first message that has not been received, and positive acknowledgments of other messages.

The fourth processing module is configured to receive a short message sent by the sending end, update a status variable of a receiving window according to the short message, and feed back a status report to the sending end.

The fifth processing module is configured to receive a second message carrying a Polling bit, wherein the second message is sent by the sending end, and is configured to, trigger an operation of sending a status message to the sending end according to the second message.

The present disclosure further provides a sending end device, including a memory, a processor, and a computer program that is stored in the memory and executable on the processor. The processor, when executing the computer program, implements steps of the method for enhancing RLC Acknowledge Mode under exceeding maximum retransmissions and dual-no conditions described in any one of the above.

The present disclosure further provides a receiving end device, including a memory, a processor, and a computer program that is stored in the memory and executable on the processor. The processor, when executing the computer program, implements steps of the method for enhancing RLC Acknowledge Mode under exceeding maximum retransmissions and dual-no conditions described in any one of the above.

The present disclosure further provides a processor-readable storage medium. The processor-readable storage medium stores a computer program. The computer program is configured to enable a processor to execute steps of the method for enhancing RLC acknowledge mode under exceeding maximum retransmissions and dual-no conditions applied to a sending end, or the method for enhancing RLC Acknowledge Mode under exceeding maximum retransmissions and dual-no conditions applied to a receiving end.

By means of the method and the apparatuses for enhancing an RLC Acknowledge Mode under exceeding maximum retransmissions and dual-no conditions which are provided in the present disclosure, when the number of retransmissions of the first message that have not been received by the receiving end reaches the preset threshold value, the first message is reconstructed into a short message, and is sent to the receiving end. The first message is the RLC/AM data message, the short message is the special RLC/AM data message with the data field length being 0, and the SN of the short message is the SN of the first message. When the polling timer expires and the dual-no conditions are met, the second message having the minimum SN in the set of messages for which positive acknowledgments of the receiving end have not been received, is sent to the receiving end. The dual-no condition is that no message in the sending buffer and the retransmission buffer can be sent at the current moment, and the new message cannot be sent due to no space in the sending window. Therefore, in the present disclosure, on the one hand, through the method of reconstructing the message with retransmission exceeding a limit into the short message, and sending to the receiving end, sending window and receiving window can be rapidly pushed to slide forward, such that premature reporting to RRC for air interface protocol reconnection is avoided; and on the other hand, by using a method of selecting messages corresponding to some message SNs more rationally, the receiving end can be triggered to send a status message as soon as possible, so as to avoid side effects. Through this method, in the RLC AM, when the retransmission of the individual message exceeds a limit, connection and reestablishment can be avoided, and protocol pause time can be shortened under the dual-no condition, thereby achieving the purpose of improving the performance of the system. The present disclosure can maintain compatibility with an existing 5G NR standard, and may effectively improve the quality of user services and the performance of the system together with layer protocols such as PDCP and RRC.

### BRIEF DESCRIPTION OF THE DRAWINGS

In order to more clearly illustrate the embodiments of the present disclosure or the technical solutions in existing technology, the drawings used in the description of the embodiments or the existing technology will be briefly described below. It is apparent that the drawings in the following descriptions are some embodiments of the present disclosure. Other drawings can be obtained from those skilled in the technology according to these drawings without any creative work.

FIG. 1 is a schematic flow chart I of a communication method applied to the RLC of the sending end in the AM according to the present disclosure.

FIG. 2 is a schematic flow chart II of a communication method applied to the RLC of the sending end in the AM according to the present disclosure.

FIG. 3 is a schematic flow chart III of a communication method applied to the RLC of the sending end in the AM according to the present disclosure.

FIG. 4 is a schematic diagram of an overall structure of the protocol stack according to the present disclosure.

FIG. 5 is a schematic diagram I of a short message format according to the present disclosure.

FIG. 6 is a schematic diagram II of a short message format according to the present disclosure.

FIG. 7 is a schematic flow chart IV of a communication method applied to an RLC of a sending end in an AM according to the present disclosure.

FIG. 8 is a schematic flow chart of a communication method applied to an RLC of a receiving end in an AM according to the present disclosure.

FIG. 9 is a schematic structural diagram of the sending end apparatus according to the present disclosure.

FIG. 10 is a schematic structural diagram of the receiving end apparatus according to the present disclosure.

FIG. 11 is a schematic structural diagram of the sending end device according to the present disclosure.

FIG. 12 is a schematic structural diagram of the receiving end device according to the present disclosure.

### DETAILED DESCRIPTION OF THE EMBODIMENTS

In order to make objectives, technical solutions, and advantages of the present disclosure clearer, the technical solutions in the present disclosure will be clearly and completely described below in combination with the drawings in the present disclosure. It is apparent that the described embodiments are part of the embodiments of the present disclosure, not all the embodiments. All other embodiments obtained by those of ordinary skill in the field on the basis of the embodiments in the present disclosure without creative work all fall within the scope of protection of the present disclosure.

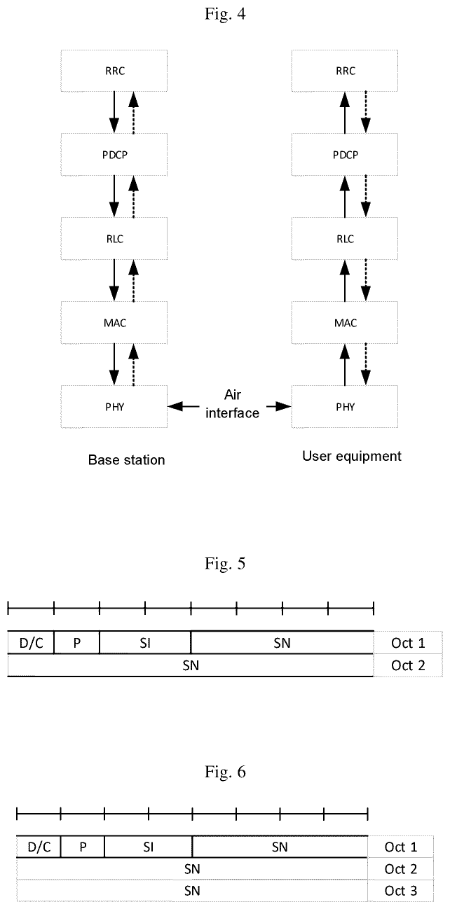

It is to be noted that, as shown in FIG. 4, a base station gNodeB (gNB) and UE communicate with each other through the air interface protocol. Data packets received by the base station from a CN are first subjected to IP header compression and encryption by a PDCP layer, then are transmitted to an RLC layer, for segmenting and concatenating according to transmission requirements of an MAC layer, are then transmitted to the MAC layer, and are finally formed air interface wireless signals for transmitting. An RLC protocol follows a 5G standard ts38.322 or a 4G standard ts36.322, and provides transmission service modes such as a TM, an UM, an AM. The RLC AM is a connection-oriented service mode that may implement functions such as ARQ error correction, duplicate packet detection, segmentation/reassembling, and RLC SDU discard processing. The functions provided by the RLC AM work in conjunction with an HARQ provided by the MAC layer to achieve more reliable transmission service.

In addition, it is to be noted that, the technical solutions provided in the present disclosure are applicable to various systems, especially a 5G system. For example, an applicable system may be a Global System of Mobile communication (GSM), a Code Division Multiple Access (CDMA) system, a Wideband Code Division Multiple Access (WCDMA) system, a General Packet Radio Service (GPRS) system, a Long Term Evolution (LTE) system, an LTE Frequency Division Duplex (FDD) system, an LTE Time Division Duplex (TDD) system, a Long Term Evolution Advanced (LTE-A) system, a Universal Mobile Telecommunication System (UMTS), a Worldwide Interoperability for Microwave Access (WiMAX) system, a 5G New Radio (NR) system, etc. The various systems all include terminal devices and network devices. The system may further include a CN portion, such as an Evolved Packet System (EPS) and a 5G System (5GS).

The terminal device involved in the present disclosure may refer to a device that provides speech and/or data connectivity to a user, a handheld device having a wireless connection function, or another processing device connected to a wireless modem. In different systems, the terminal device may have different names. For example, in the 5GS, the terminal device may be referred to as UE. A wireless terminal device may communicate with one or more CNs via a Radio Access Network (RAN). The wireless terminal device may be a mobile terminal device, such as a mobile phone (or referred to as a “cellular” phone) and a computer having a mobile terminal device, for example, portable, pocket-sized, handheld, computer built-in, or vehicle mobile apparatuses, which exchange language and/or data with a wireless access network. For example, the wireless terminal device is a device such as a Personal Communication Service (PCS) phone, a cordless phone, a Session Initiated Protocol (SIP) phone, a Wireless Local Loop (WLL) station, a Personal Digital Assistant (PDA), or the like. The wireless terminal device may also be referred to as a system, a subscriber unit, a subscriber station, a mobile station, a mobile, a remote station, an access point, a remote terminal, an access terminal, a user terminal, a user agent, or a user device, which is not limited in the embodiments of the present disclosure. Since the terminal device and other network devices (such as a CN device and an access network device (i.e., a base station)) together form a network that may support a communication, in the present disclosure, the terminal device is also regarded as a network device.

The network device involved in the embodiments of the present disclosure may be a base station. The base station may include a plurality of cells providing services for the UE, or may also be a Central Unit (CU) or a Distributed Unit (DU). According to different specific application scenarios, the network device may also be referred to as an access point, or may be a device in an access network that communicates with a wireless terminal device through one or more sectors on an air interface, or other names. The network device may be configured to interchange received air frames with IP packets, and be taken as a router between the wireless terminal device and the rest of the access network. The rest of the access network may include an IP communication network. The network device may also coordinate the management of attributes of the air interface. For example, the network device involved in the embodiments of the present disclosure may be a network device (Base Transceiver Station (BTS)) in a Global System for Mobile communications (GSM) or Code Division Multiple Access (CDMA) system, or a network device (NodeB) in Wide-band Code Division Multiple Access (WCDMA) system, or an evolutional network device (evolutional Node B, eNB or e-NodeB) in an LTE system, a 5G base station (gNB) in a 5G network architecture (next generation system), and also a Home evolved Node B (HeNB), relay node, a home base station (femto), a pico base station (pico), etc., which is not limited in the embodiments of the present disclosure. In some network structures, the network device may include a Centralized Unit (CU) node and a Distributed Unit (DU) node. The CU and the DU may also be geographically separately arranged.

In the present disclosure, the base station and the UE may both be sending ends and receiving ends. Without losing generality, in the following embodiments, the base station is described as the sending end and the UE as the receiving end.

The present disclosure is described below.

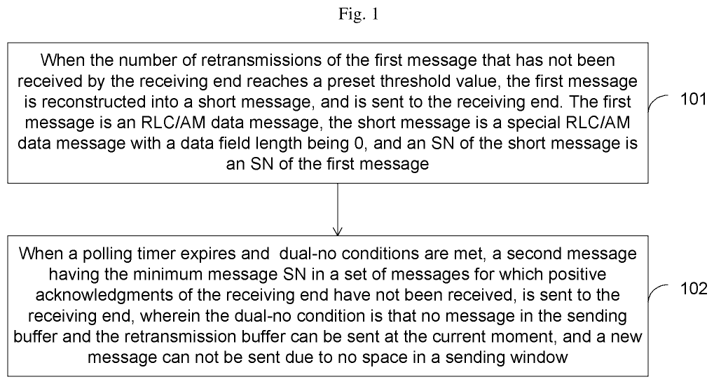

As shown in FIG. 1, the method for enhancing RLC acknowledge mode under exceeding maximum retransmissions and dual-no conditions is applied to a sending end, and the method provided in the present disclosure includes the following steps.

At S101, when the number of retransmissions of a first message that has not been received by a receiving end reaches a preset threshold value, the first message is reconstructed into a short message, and the short message is sent to the receiving end. The first message is an RLC/AM data message, the short message is a special RLC/AM data message with a data field length being 0, and an SN of the short message is an SN of the first message.

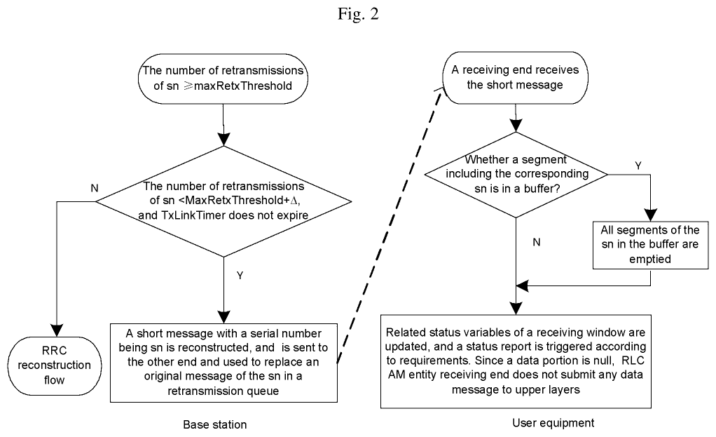

In this step, before the first message that has not been received by UE is retransmitted, the base station first receives a status message sent by the UE. The status message includes Negative Acknowledgment (NACK) information of an SN message that has not been completely received by the UE or of a segment of the SN message, and positive Acknowledgment (ACK) information of other messages explicitly or implicitly; and the SN of the short message is the SN of the first message. After receiving the status message sent by the UE, the base station finds ACK of messages with the message SN such as sn−1, sn+1, . . . , sn+i. A sending link available state timer TxLinkTimer for the UE (the timer is newly disposed in the present disclosure, and needs to be restarted every time when the status message explicitly or implicitly includes a new acknowledged SN) is started, and the timer expires after predefined time TxLinkLive. If a message with the SN being sn or a segment with the SN being sn needs to be retransmitted, and after the number of retransmissions adds 1, it is further found that the obtained number of retransmissions has exceeded the maximum number, meanwhile the timer TxLinkTimer is valid, a short message is constructed and sent to the UE. For example, as shown in FIG. 2, when the message with the SN being sn has exceeded the maximum number max Retx Threshold of retransmissions, and the timer TxLinkTimer is valid, instead of following the existing ts38.322 process (reporting to RRC, and starting the RRC for reconnection), a PDU data length of the message with the SN being sn is set to 0 (i.e., a data portion is empty) to form the short message, and then the short message is sent to the UE; and if the TxLinkTimer expires, processing is still performed according to the existing ts38.322 process (reporting to the RRC, and starting the RRC for reconnection). A PDU format of the short message is shown in FIG. 5 and FIG. 6.

At S102, when a polling timer expires and a dual-no condition is met, a second message having the minimum message SN in a set of messages for which positive acknowledgments of the receiving end have not been received, is sent to the receiving end. The dual-no condition is that no message in the sending buffer and the retransmission buffer can be sent at the current moment, and a new message cannot be sent due to no space in a sending window.

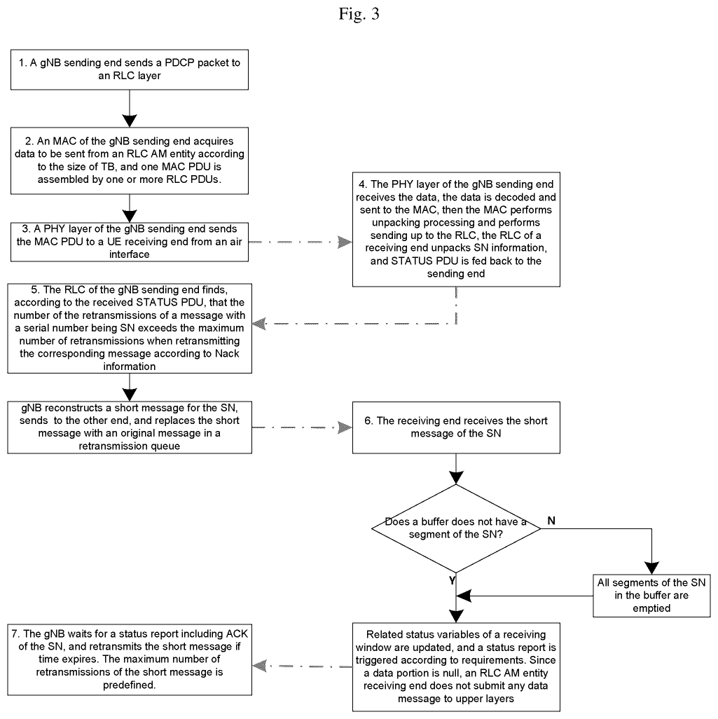

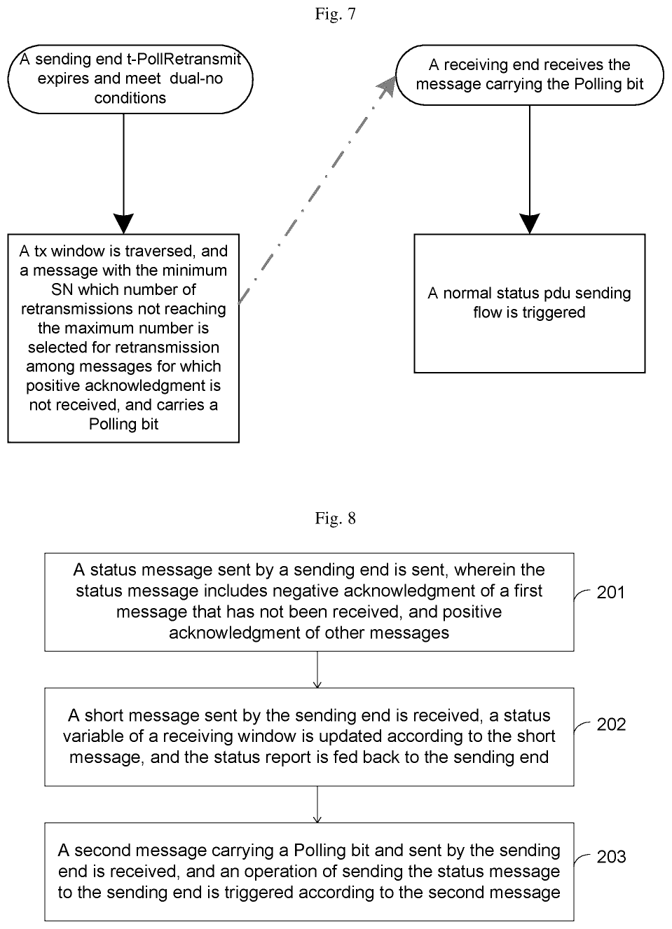

In this step, as shown in FIG. 3, during a processing process from S2 to S3, the base station sets a Polling flag bit in a currently-sent AM PDU when conditions of section 5.3.3.2 of the standard ts38.322 are met; and the SN of the current PDU is saved as SNp, a timer t-PollRetransmit is started at the moment. If the t-PollRetransmit expires and meets the dual-no condition, a message with the minimum SN is preferably selected for retransmission from messages for which positive acknowledgment has not been received, wherein the number of the retransmissions of the selected message does not reach the maximum number, and the selected message carries a Polling bit. As shown in FIG. 7, a specific process is that, after a certain period of time, the timer t-PollRetransmit expires (indicating that the status message including the ACK of message with SN being SNp has not been received) and meets the dual-no condition, an AM entity of the sending end preferably selects an SN message with the minimum message SN from a current sending window, wherein the positive acknowledgment for the selected SN message has not been received and the number of retransmissions of the selected SN message does not reach the maximum number (if the number of retransmissions of all messages for which acknowledgment have not been received, reaches the maximum number of retransmissions, the message with the minimum SN is selected from the all messages). After the SN message to be retransmitted is selected, the Polling flag bit is inserted in the message at the same time, and the message is sent by an RLC AM entity. If the status message including the SNp is received before the timer t-PollRetransmit expires, the timer t-PollRetransmit is stopped and reset. It is to be noted that, according to a solution provided by the existing protocol standard, a PDU with the maximum SN has been sent to the UE is found for retransmission and Polling is set, or a PDU corresponding to the SN for which positive acknowledgment is not received is randomly found for retransmission and Polling is set. If the PDU with the maximum SN is set to be retransmitted, the SN may not meet SN<RX_Highest_Status, or SN>=RX_Next+AM_Window_Size in the receiving end, such that a status report cannot be triggered timely; and if the random PDU (for example, the PDU with the minimum SN) is set to be retransmitted, the maximum number of retransmissions may have been reached already, and a link failure event is easily triggered due to another retransmission, causing the reset of the RLC connection.

By means of the method for enhancing an RLC acknowledge mode under exceeding maximum retransmissions and dual-no conditions provided in the present disclosure, when the number of retransmissions of the first message that has not been received by the receiving end reaches the preset threshold value, the first message is reconstructed into the short message, and the short message is sent to the receiving end. The first message is the RLC/AM data message, the short message is the special RLC/AM data message with the data field length being 0, and the SN of the short message is the SN of the first message. When the polling timer expires and the dual-no condition is met, the second message having the minimum message SN in the set of messages for which positive acknowledgment of the receiving end has not been received, is sent to the receiving end. The dual-no condition is that no message in the sending buffer and the retransmission buffer can be sent at the current moment, and the new message cannot be sent due to no space in the sending window. Therefore, in the present disclosure, on the one hand, through the method of reconstructing the message with retransmission exceeding a limit into the short message, and sending to the receiving end, the sending window and the receiving window may be rapidly pushed to slide forward, such that premature reporting to RRC for air interface protocol reconnection is avoided; and on the other hand, by using a method of selecting messages corresponding to some message SNs more rationally, the receiving end may be triggered to send a status message as soon as possible, so as to avoid side effects. Through the method, in the RLC AM, when the retransmission of the individual message exceeds a limit, connection and reestablishment may be avoided, and protocol pause time is shortened under the dual-no conditions, thereby achieving the purpose of improving the performance of the system. The present disclosure can maintain compatibility with an existing 5G NR standard, and can effectively improve the quality of user services and the performance of the system together with layer protocols such as PDCP and RRC.

Based on the content of the embodiments, in this embodiment, before the first message that has not been received by the receiving end is retransmitted, the method further includes the following operation.

A status message sent by the receiving end is received, and a sending link available status timer for a receiving end is started. The status message includes negative acknowledgment of the first message, and positive acknowledgment of other messages.

In this embodiment, when the status message explicitly or implicitly includes the SN that is not acknowledged previously, the sending end restarts the sending link available state timer.

Based on the content of the embodiments, in this embodiment, when the number of retransmissions of the first message that has not been received by the receiving end reaches the preset threshold value, reconstructing the first message into the short message, and sending to the receiving end includes the following operations.

When the number of retransmissions of the first message that has not been received by the receiving end reaches the preset threshold value, if the sending link available status timer for the receiving end is valid, the first message is reconstructed into the short message, and is sent to the receiving end.

If the sending link available status timer for the receiving end expires, or the number of retransmissions of the short message reaches the preset threshold value, an RRC layer is reported for reconnection of an air interface protocol.

In this embodiment, if within preset time, the status message which is sent by the receiving end and includes positive acknowledgment of the short message has not been received, the short message is retransmitted.

Based on the content of the embodiments, in this embodiment, when the polling timer expires and the dual-no condition is met, sending the second message having the minimum message SN in the set of messages to the receiving end, for which positive acknowledgment of the receiving end has not been received includes the following operation.

If the number of retransmissions of all messages in the set of messages, for which positive acknowledgment of the receiving end has not been received, has reached the preset threshold value, the second message having the minimum message SN is selected and sent to the receiving end, otherwise the second message having the minimum message SN and the number of retransmissions not reaching the preset threshold value is sent to the receiving end.

Specific embodiments are described below.

First embodiment is provided below.

In this embodiment, as shown in FIG. 2, when the number of retransmissions of an individual message exceeds the maximum number of retransmissions, the sending window and the receiving window may be rapidly pushed to slide forward by using a method of sending a short message including a message SN of the individual message, such that premature reporting to RRC for air interface protocol reconnection is avoided.

In this embodiment, the number of retransmissions of the individual message exceeding the maximum number of retransmissions refers to that there are other messages sent successfully (acknowledgment has been received) by the sending end within predefined time, and the number of retransmissions of these messages does not exceed the maximum number of retransmissions. The short message is a PDU in an RLC AM, a data length of the short message is set to 0, and the SN of the short message is the SN of the PDU which the number of retransmissions exceeding the maximum number of retransmissions. Pushing the sending window to slide forward refers to that a lower edge TX_Next_Ack of the sending window of the sending end moves upwards. Pushing the receiving window to slide forward refers to that updating an RX_Next status variable, and at the same time, according to the SN of the current short message, updating status variables such as RX_Highest_Status, RX_Next_Highest, and RX_Next_Status_Trigger according to requirements. The avoidance of premature reporting to RRC for air interface protocol reconnection refers to that this event is not reported to an RRC when the number of retransmissions reach the maximum number of retransmissions, so as to trigger air interface protocol reconnection, and the short message is continuously retransmitted until the number of retransmissions reach the predefined number of subsequent retransmissions before reporting to the RRC for a reconnection operation.

In this embodiment, as shown in FIG. 7, when the polling timer t-PollRetransmit expires, Polling needs to be sent if the sending end is under the condition (referred to the dual-no condition) that no message in the sending buffer and the retransmission buffer can be sent or a new message cannot be sent due to reasons such as no space in the sending window, a method of selecting messages of some SNs rationally for retransmission is adopted, so that the receiving end may be triggered to send a status message as soon as possible, so as to avoid side effects. The method of selecting messages of some SNs rationally for retransmission refers to that the message with the minimum SN which number of retransmissions not reaching the maximum number is preferably selected for retransmission among messages for which positive acknowledgment have not been received (if all messages which acknowledgments have not been received, have reached the maximum number of retransmissions, the message with the minimum SN is selected), and carries the Polling bit. Triggering the receiving end to send the status message as soon as possible refers to that, after the message with a small SN reaches the receiving end, SN is more likely to meet SN<RX_Highest_Status or SN>=RX_Next+AM_Window_Size as specified in standard ts38.322, such that the status message is triggered. The avoidance of the side effects refers to that the number of retransmissions of the retransmitted messages do not reach the maximum number of retransmissions, such that the RRC is prevented from performing related processing such as air interface protocol reconnection.

Therefore, a method for reducing connection reestablishment and polling-triggered retransmitted messages by RLC protocol in AM is disclosed in the present disclosure, and relates to a wireless communication network such as 5G and 4G, such that the problems of unnecessary connection reestablishment or long pause time in some cases can be solved. The present disclosure includes: when only the number of retransmissions of an individual message exceeds the maximum number of retransmissions, using the method of sending the short message including the message SN to promote the sending window and the receiving window to slide rapidly, so as to avoid premature reporting to the RRC for air interface protocol reconnection; and when the polling timer expires and needs to send polling, and if no message in the sending buffer and the retransmission buffer can be sent or the new message cannot be sent due to reasons such as no space in the sending window, retransmission is performed by preferably selecting the message with the minimum SN which the number of retransmissions has not reached the maximum number among the messages and positive acknowledgments have not been received, and the Polling bit is carried. The present disclosure is suitable for data transmission between a base station and the UE in network such as 5G and 4G, such that communication performance of the RLC layer in the AM can be effectively improved.

Second embodiment is provided below.

In this embodiment, as shown in FIG. 3, in RLC AM, a base station gNB sending end sends a data packet of the PDCP layer to an AM entity of an RLC layer according to service characteristics, so as to form data to be sent by an RLC AM entity. An MAC of the gNB sending end acquires the data to be sent according to requirements from entities such as the RLC AM entity, and one MAC PDU is assembled by one or more RLC PDUs. The RLC AM PDU formed by the data to be sent from the RLC AM entity includes fields such as SN, P, SI, SO, and data. A physical layer of the gNB sending end sends the MAC PDU to a UE receiving end from an air interface. A physical layer of the UE receiving end receives a message sent from the air interface, and uploads it to the MAC after successful decoding; and the MAC performs unpacking processing on the received message to obtain an AM PDU message, and uploads it to the RLC AM entity. Assuming that SNs included in the AM PDU messages completely received within a certain period of time are sn−1, sn+1, . . . , sn+i; and sn+i is located in the receiving window, but the message with the SN being sn has not been completely received. Therefore, the RLC AM receiving end constructs the corresponding status message, and sends it to an RLC AM sending end of the base station side. The status message includes the NACK information of the SN message or of a segment of the SN message, and explicit or implicit ACK information of other messages. After receiving the status message, the gNB finds the ACK of the messages such as sn−1, sn+1, . . . , sn+i. A sending link available state timer TxLinkTimer for the UE is started, and the timer expires after predefined time TxLinkLive. It is found that a message with the SN being sn or a segment with the SN being sn needs to be retransmitted, after the number of retransmissions adds 1, it is further found that the timer TxLinkTimer is valid when the number of retransmissions had exceeded the maximum number, a short message is constructed and sent to a receiving end.

As shown in FIG. 8, the method for enhancing RLC acknowledge mode under exceeding maximum retransmissions and dual-no conditions applied to a receiving end provided in the present disclosure includes the following steps.

At S201, a status message sent by a sending end is sent. The status message includes negative acknowledgment of a first message that has not been received, and positive acknowledgment of other messages.

In this step, the physical layer of the UE receiving end receives the message sent from the air interface, and uploads to the MAC after successful decoding; and the MAC performs unpacking processing on the received message to obtain the AM PDU message, and uploads to the RLC AM entity. Assuming that SNs included in the AM PDU messages completely received within a certain period of time are sn−1, sn+1, . . . , sn+i; and sn+i is located in the receiving window, but the SN message has not been completely received. Therefore, the RLC AM receiving end constructs the corresponding status message, and sends to an RLC AM sending end of the base station side. The status message includes the NACK information of the sn message or the segment, and explicit or implicit ACK information of other messages.

At S202, a short message sent by the sending end is received, a status variable of the receiving window is updated according to the short message, and the status report is fed back to the sending end.

In this step, as shown in FIG. 2, the UE receiving end receives the short message sent by the base station side. If a data length portion is 0 after a corresponding message header is analyzed, it is considered as the short message; segments (if have) corresponding to an original sn buffered are cleared according to other information such as the SN obtained by analyzing message header information; and then related status variables of the receiving window are updated, and the status report is triggered according to requirements. Since a data portion is null, the RLC AM entity receiving end does not submit any data message to upper layers. Accordingly, a base station sending end waits for the status report of the ACK including the sn; the short message is continuously retransmitted if the base station sending end does not receive the report; and if the total number of retransmissions of the SN exceeds the maximum number maxRetxThreshold added by subsequent number Δ (Δ is a predefined positive integer), the RRC is reported to perform a reconnection operation. With the same channel error rate, the probability of sending the short message correctly is improved greatly, such that the sending and receiving windows can be pushed to slide forward rapidly. Therefore, the present disclosure is more likely to push the windows to slide than a method of simply increasing the number of retransmissions of an original message, and more rational than a method of prematurely reporting to the RRC for reconnection. The rest of the behavior on both the sending and receiving ends remains compatible with the existing standard ts38.322 and makes the performance improved.

At S203, a second message carrying a Polling bit and sent by the sending end is received, and an operation of sending the status message to the sending end is triggered according to the second message.

In this step, as shown in FIG. 7, the UE receives the message carrying the Polling bit, wherein the message is sent by the base station, and the UE is triggered a normal flow of sending the status message to the base station according to the message.

Therefore, in the present disclosure, when only the number of retransmissions of an individual message exceeds the maximum number of retransmissions, the method of sending the short message including the message SN is used to promote the sending window and the receiving window to slide rapidly, so as to avoid premature reporting to the RRC for air interface protocol reconnection; and when the polling timer expires and needs to send polling, and if no message in the sending buffer and the retransmission buffer can be sent or the new message cannot be sent due to reasons such as no space in the sending window, the message with the minimum SN is preferably selected for retransmission among messages for which positive acknowledgments have not been received, wherein the number of retransmissions of the selected message does not reach the maximum number, and the selected message carries the Polling bit. The present disclosure is suitable for data transmission between a base station and the UE in the network such as 5G and 4G, such that communication performance of the RLC in the AM can be effectively improved.

Based on the content of the embodiments, in this embodiment, the short message is a special RLC/AM data message with a data field length being 0, and the SN of the short message is the SN of the first message.

Based on the content of the embodiments, in this embodiment, the second message is a message having the minimum message SN that is selected in a set of messages for which positive acknowledgments of the sending end have not been received.

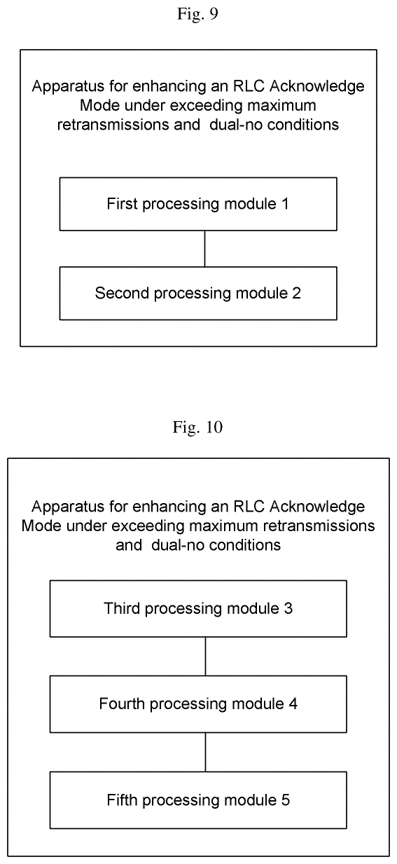

In addition, FIG. 9 is a schematic structural diagram of an apparatus applied to a base station or UE. The apparatus includes a first processing module 1 and a second processing module 2.

The first processing module 1 is configured to, when the number of retransmissions of the first message that has not been received by a receiving end reaches a preset threshold value, reconstruct the first message into a short message, and send to the receiving end. The first message is an RLC/AM data message, the short message is a special RLC/AM data message with a data field length being 0, and the SN of the short message is the SN of the first message.

The second processing module 2 is configured to, when a polling timer expires and a dual-no condition is met, send, to the receiving end, a second message having the minimum message SN in a set of messages for which positive acknowledgment of the receiving end has not been received. The dual-no condition is that no message in the sending buffer and the retransmission buffer can be sent at the current moment, and a new message cannot be sent due to no space in a sending window.

Based on the content of the embodiments, in this embodiment, before retransmitting the first message that has not been received by the receiving end, the first processing module is further configured to perform the following operation.

A status message sent by the receiving end is received, and a sending link available status timer for a receiving end is started. The status message includes negative acknowledgment of the first message, and positive acknowledgment of other messages.

It is to be noted here that, the apparatus can implement all method steps of the method embodiments for enhancing RLC acknowledge mode under exceeding maximum retransmissions and dual-no conditions, wherein the method embodiments are applied to the sending end of the base station or the UE, and the apparatus can achieve the same technical effect, such that details are not described herein again.

In addition, FIG. 10 is a schematic structural diagram of an apparatus applied to a receiving end of a base station or UE. The apparatus includes a third processing module 3, a fourth processing module 4, and a fifth processing module 5.

The third processing module 3 is configured to send a status message sent by a sending end. The status message includes negative acknowledgment of a first message that has not been received, and positive acknowledgment of other messages.

The fourth processing module 4 is configured to receive a short message sent by the sending end, update a status variable of the receiving window according to the short message, and feed back the status report to the sending end.

The fifth processing module 5 is configured to receive a second message carrying a Polling bit and sent by the sending end, and trigger an operation of sending the status message to the sending end according to the second message.

It is to be noted here that, the apparatus can implement all method steps of the method embodiments for enhancing RLC acknowledge mode under exceeding maximum retransmissions and dual-no conditions, wherein the method embodiments are applied to the receiving end, and can achieve the same technical effect, such that details are not described herein again.

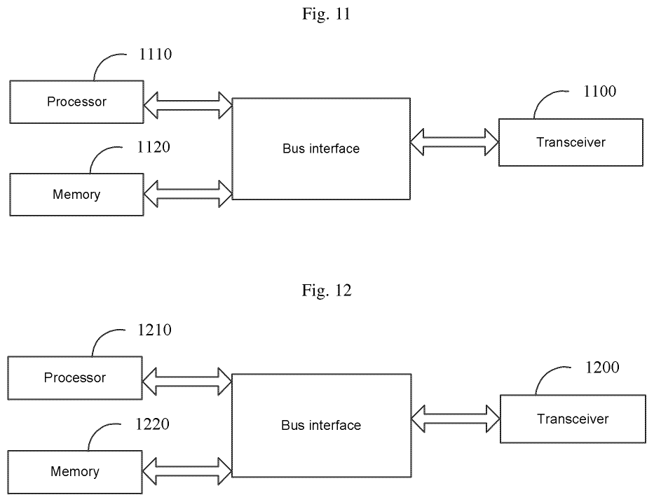

FIG. 11 is a schematic structural diagram I of a sending end device according to the present disclosure. The sending end device includes a memory 1120, a transceiver 1100, and a processor 1110.

In FIG. 11, a bus architecture may include any number of interconnected buses and bridges, and is specifically formed by linking various circuits together by one or more processors, represented by the processor 1110, and a memory, represented by the memory 1120. The bus architecture may also connect various other circuits such as periphery devices, voltage regulators, and power management circuits together, all of which are well known in the art and therefore will not be further described herein. A bus interface provides an interface. The transceiver 1100 may be a plurality of elements, i.e., includes a sender and a receiver, and provides units configured to communicate with various other apparatuses on transmission media. These transmission media include transmission media such as wireless channels, wired channels, cables, etc. The processor 1110 is responsible for managing the bus architecture and general processing. The memory 1120 may be configured to store data used by the processor 1110 during execution of operations.

The processor 1110 may be a Central Processing Unit (CPU), an Application Specific Integrated Circuit (ASIC), a Field-Programmable Gate Array (FPGA), or a Complex Programmable Logic Device (CPLD), or the processor may use a multi-core architecture.

The memory 1120 is configured to store a computer program. The transceiver 1100 is configured to receiving and sending data under the control of the processor. The processor 1110 is configured to read the computer program in the memory and execute the following operations.

When the number of retransmissions of a first message that has not been received by a receiving end reaches a preset threshold value, the first message is reconstructed into a short message, and is sent to the receiving end. The first message is an RLC/AM data message, the short message is a special RLC/AM data message with a data field length being 0, and an SN of the short message is an SN of the first message.

When a polling timer expires and a dual-no condition is met, a second message having the minimum message SN in a set of messages, for which positive acknowledgment of the receiving end has not been received, is sent to the receiving end. The dual-no condition is that no message in the sending buffer and the retransmission buffer can be sent at the current moment, and a new message cannot be sent due to no space in a sending window.

It is to be noted here that, the sending end device provided in the present disclosure can implement all method steps of the method embodiments for enhancing RLC acknowledge mode under exceeding maximum retransmissions and dual-no conditions, wherein the method embodiments are applied to the sending end device, and can achieve the same technical effect, such that details are not described herein again.

FIG. 12 is a schematic structural diagram I of a sending end device according to the present disclosure. The sending end device includes a memory 1220, a transceiver 1200, and a processor 1210.

In FIG. 12, a bus architecture may include any number of interconnected buses and bridges, and is specifically formed by linking various circuits together by one or more processors, represented by the processor 1210, and a memory, represented by the memory 1220. The bus architecture may also connect various other circuits such as periphery devices, voltage regulators, and power management circuits together, all of which are well known in the art and therefore will not be further described herein. A bus interface provides an interface. The transceiver 1200 may be a plurality of elements, i.e., includes a sender and a receiver, and provides units configured to communicate with various other apparatuses on transmission media. These transmission media include transmission media such as wireless channels, wired channels, cables, etc. The processor 1210 is responsible for managing the bus architecture and general processing. The memory 1220 may be configured to store data used by the processor 1210 during execution of operations.

The processor 1210 may be a Central Processing Unit (CPU), an Application Specific Integrated Circuit (ASIC), a Field-Programmable Gate Array (FPGA), or a Complex Programmable Logic Device (CPLD), or the processor may use a multi-core architecture.

The memory 1220 is configured to store a computer program. The transceiver 1200 is configured to receiving and sending data under the control of the processor. The processor 1210 is configured to read the computer program in the memory and execute the following operations.

A status message is sent to a sending end. The status message includes negative acknowledgment of a first message that has not been received, and positive acknowledgment of other messages.

A short message sent by the sending end is received, a status variable of a receiving window is updated according to the short message, and the status report is fed back to the sending end.

A second message carrying a Polling bit and sent by the sending end is received, and an operation of sending the status message to the sending end is triggered according to the second message.

It is to be noted here that, the receiving end device provided in the present disclosure can implement all method steps of the method embodiments for enhancing RLC acknowledge mode under exceeding maximum retransmissions and dual-no conditions, wherein the method embodiments are applied to the receiving end device, and can achieve the same technical effect, such that details are not described herein again.

It is to be noted that, the unit division in the present disclosure is exemplary, and is merely logical function division. During actual implementation, the units may be divided in other manners. In addition, the functional units in the various embodiments of the application may be integrated into one processing unit, or each unit may exist alone physically, or two or more than two units may be integrated into one unit. The above integrated unit can be implemented in the form of hardware, or can be implemented in the form of a software functional unit.

If the integrated unit is implemented in the form of the software functional unit and sold or used as an independent product, it can be stored in a processor-readable storage medium. Based on this understanding, the technical solutions of the present disclosure essentially or the parts that contribute to the related art, all or part of the technical solutions can be embodied in the form of a software product. The computer software product is stored in a storage medium, including a plurality of instructions for causing a computer device (which may be a personal computer, a server, or a network device, and the like) or the processor to execute all or part of the steps of the method described in the various embodiments of the present disclosure. The storage medium includes: various media capable of storing program codes such as a U disk, a mobile Hard Disk Drive (HDD), a Read-Only Memory (ROM), a Random Access Memory (RAM), a magnetic disk or an optical disk.

It is to be noted here that, the apparatus provided in the present disclosure can implement all method steps implemented by the method embodiments, and can achieve the same technical effect, and the part and beneficial effects same as the method embodiments in this embodiment are no longer described in detail.

In another aspect, the present disclosure further provides a processor-readable storage medium. The processor-readable storage medium is configured to store a computer program. The computer program is used for enabling a processor to execute the method in the embodiments.

The processor-readable storage medium may be any usable medium or data storage device that the processor is able to access, including, but not limited to, magnetic memories (e.g., floppy disks, hard disks, magnetic tapes, magnetic optical disks (MO), etc.), optical memories (e.g., CDs, DVDs, BDs, HVDs, etc.), and semiconductor memories (e.g., ROMs, EPROMS, EEPROMs, nonvolatile memory (NAND FLASH), Solid State Disk (SSD)), etc.

From the embodiments, it may be seen that, the processor-readable storage medium stores a computer program. The computer program is used for enabling a processor to execute steps of the method for enhancing RLC acknowledge mode under exceeding maximum retransmissions and dual-no conditions.

Those technical personnel in this field should understand that the embodiments of the application may be provided as a method, a system, or a computer program product. Therefore, the present disclosure may adopt forms of complete hardware embodiments, complete software embodiments or embodiments integrating software and hardware. Moreover, the application may adopt the form of a computer program product implemented on one or more computer available storage media (including but being not limited to a disk memory, an optical memory, and the like) containing computer available program codes.

This application is described with reference to flowcharts and/or block diagrams of the method, the device (system) and the computer program product according to the embodiments of this application. It should be understood that each flow and/or box in the flowchart and/or block diagram, and the combination of the flow and/or box in the flowchart and/or block diagram may be implemented by computer executable instructions. These computer executable instructions may be provided to a processor of a general-purpose computer, a special-purpose computer, an embedded processor or other programmable data processing devices to generate a machine, so that instructions which are executed by the processor of the computer or other programmable data processing devices generate a device which is used for implementing the specified functions in one or more flows of the flowchart and/or one or more blocks of the block diagram.

These processor executable instructions may also be stored in the processor-readable memory which can guide the computer or other programmable data processing devices to work in a particular way, so that the instructions stored in the processor-readable memory generate a product including an instruction device. The instruction apparatus implements the specified functions in one or more flows of the flowchart and/or one or more boxes of the block diagram.

These processor executable instructions may also be loaded on the computer or other programmable data processing devices, so that a series of operation steps are performed on the computer or other programmable data processing devices to generate the processing implemented by the computer, and the instructions executed on the computer or other programmable data processing devices provide the steps for implementing the specified functions in one or more flows of the flowchart and/or one or more boxes of the block diagram.

It is apparent that technical personnel in this field can make various modifications and variations to this application without departing from the spirit and scope of this application. Thus, if such modifications and variations of the present disclosure fall within the scope of the appended claims and their equivalents, the present disclosure is also intended to cover the modifications and variations.

What is claimed is:

1. A method for enhancing a Radio Link Control (RLC) Acknowledge Mode under exceeding maximum retransmissions and dual-no conditions, applied to a sending end and comprising:
when the number of retransmissions of a first message that has not been received by a receiving end reaches a preset threshold value, reconstructing the first message into a short message, and sending the short message to the receiving end, wherein the first message is an RLC/AM data message, the short message is a special RLC/AM data message with a data field length being 0, and a Sequence Number (SN) of the short message is an SN of the first message; and
when a polling timer expires and a dual-no condition is met, sending, to the receiving end, a second message having a minimum message SN in a set of messages for which positive acknowledgments of the receiving end have not been received, wherein the dual-no condition is that no message in the sending buffer and the retransmission buffer can be sent at a current moment, and a new message cannot be sent due to no space in a sending window.

2. The method for enhancing RLC AM under exceeding maximum retransmissions and dual-no conditions as claimed in claim 1, wherein before the first message that has not been received by the receiving end is retransmitted, the method further comprises:
receiving a status message sent by the receiving end, and starting a sending link available status timer for a receiving end, wherein the status message comprises negative acknowledgment of the first message, and positive acknowledgment of other messages.

3. The method for enhancing RLC AM under exceeding maximum retransmissions and dual-no conditions as claimed in claim 2, wherein, when the number of retransmissions of the first message that has not been received by the receiving end reaches the preset threshold value, reconstructing the first message into the short message, and sending to the receiving end comprises:
when the number of retransmissions of the first message that has not been received by the receiving end reaches the preset threshold value, if the sending link available status timer for the receiving end is valid, reconstructing the first message into the short message, and sending to the receiving end; and
if the sending link available status timer for the receiving end expires, or the number of retransmissions of the short message reaches the preset threshold value, reporting to a Radio Resource Control (RRC) for reconnection of an air interface protocol.

4. The method for enhancing RLC AM under exceeding maximum retransmissions and dual-no conditions as claimed in claim 1, wherein, when the polling timer expires and the dual-no condition is met, sending, to the receiving end, the second message having the minimum message SN in the set of messages for which positive acknowledgment of the receiving end is not received comprises:
if the number of retransmissions of all messages in the set of messages for which positive acknowledgments of the receiving end have not been received, has reached the preset threshold value, selecting and sending the second message having the minimum message SN to the receiving end,
otherwise sending the second message having the minimum message SN and of which number of retransmissions not reaching the preset threshold value to the receiving end.

5. A method for enhancing Radio Link Control (RLC) Acknowledge Mode under exceeding maximum retransmissions and dual-no conditions, applied to a receiving end and comprising:
sending a status message to a sending end, wherein the status message comprises negative acknowledgment of a first message that has not been received, and positive acknowledgment of other messages;
receiving a short message sent by the sending end, updating a status variable of a receiving window according to the short message, and feeding back a status report to the sending end; and
receiving a second message carrying a Polling bit and sent by the sending end, and according to the second message, triggering an operation of sending the status message to the sending end.

6. The method for enhancing RLC Acknowledge Mode under exceeding maximum retransmissions and dual-no conditions as claimed in claim 5, wherein the short message is a special RLC/AM data message with a data field length being 0, and a Sequence Number (SN) of the short message is an SN of the first message.

7. The method for enhancing RLC Acknowledge Mode under exceeding maximum retransmissions and dual-no conditions as claimed in claim 5, wherein the second message is a message having a minimum message SN that is selected in a set of messages for which positive acknowledgments of the sending end have not been received.

8-10. (canceled)

11. A sending end device, comprising a memory, a processor, and a computer program that is stored in the memory and executable on the processor, wherein the processor, when executing the computer program, implements steps of the method for enhancing RLC Acknowledge Mode with retransmission exceeding following actions:
when the number of retransmissions of a first message that has not been received by a receiving end reaches a preset threshold value, reconstructing the first message into a short message, and sending the short message to the receiving end, wherein the first message is an RLC/AM data message, the short message is a special RLC/AM data message with a data field length being 0, and a Sequence Number (SN) of the short message is an SN of the first message; and
when a polling timer expires and a dual-no condition is met, sending, to the receiving end, a second message having a minimum message SN in a set of messages for which positive acknowledgments of the receiving end have not been received, wherein the dual-no condition is that no message in the sending buffer and the retransmission buffer can be sent at a current moment, and a new message cannot be sent due to no space in a sending window.

12-13. (canceled)

14. The sending end device as claimed in claim 11, wherein before the first message that has not been received by the receiving end is retransmitted, the processor further implements following actions:
receiving a status message sent by the receiving end, and starting a sending link available status timer for a receiving end, wherein the status message comprises negative acknowledgment of the first message, and positive acknowledgment of other messages.

15. The sending end device as claimed in claim 14, wherein, when the number of retransmissions of the first message that has not been received by the receiving end reaches the preset threshold value, reconstructing the first message into the short message, and sending to the receiving end comprises:
when the number of retransmissions of the first message that has not been received by the receiving end reaches the preset threshold value, if the sending link available status timer for the receiving end is valid, reconstructing the first message into the short message, and sending to the receiving end; and
if the sending link available status timer for the receiving end expires, or the number of retransmissions of the short message reaches the preset threshold value, reporting to a Radio Resource Control (RRC) for reconnection of an air interface protocol.

16. The sending end device as claimed in claim 11, wherein, when the polling timer expires and the dual-no condition is met, sending, to the receiving end, the second message having the minimum message SN in the set of messages for which positive acknowledgments of the receiving end have not been received comprises:
if the number of retransmissions of all messages in the set of messages for which positive acknowledgments of the receiving end have not been received, has reached the preset threshold value, selecting and sending the second message having the minimum message SN to the receiving end,
otherwise sending, to the receiving end, the second message having the minimum message SN and of which number of retransmissions not reaching the preset threshold value.
